(19) United States
(12) Patent Application Publication
(10) Pub. No.: US 2026/0010185 A1
(43) Pub. Date: Jan. 8, 2026

(54) DEVICE AND METHOD FOR SENSING AND PROCESSING LAND TRANSPORT ENVIRONMENT OF VEHICLE

(71) Applicant: WILLOG CO., LTD., Seoul (KR)

(72) Inventors: Sunghoon BAE, Seoul (KR); Jihyun YUN, Seoul (KR); Jaehwan KIM, Seoul (KR)

(73) Assignee: WILLOG CO., LTD., Seoul (KR)

(21) Appl. No.: 19/128,626

(22) PCT Filed: Nov. 10, 2023
(86) PCT No.: PCT/KR2023/018111

§ 371 Date: May 9, 2025

(30) Foreign Application Priority Data
Nov. 10, 2022 (KR) 10-2022-0149744
Nov. 9, 2023 (KR) 10-2023-0154927
Nov. 9, 2023 (KR) 10-2023-0154929

(51) Int. Cl. G05D 19/02; G01D 9/00

(52) U.S. Cl. CPC G05D 19/02; G01D 9/007

(57) ABSTRACT

The present disclosure relates to a device and method for sensing and processing a land transportation environment of a vehicle. According to an embodiment of the present disclosure, the device includes an inertial sensor that senses an impact on cargo contained in the cargo compartment due to the rapid acceleration or deceleration of a vehicle, a processor that calculates a second frequency to cancel out a first frequency corresponding to the sensed impact and outputs a control signal including the second frequency, and a vibration generator that vibrates at the second frequency in response to the control signal.

### FIELD OF THE INVENTION

The present disclosure relates to an electronic device and method, and more specifically, to a device and method for sensing and processing the land transport environment of a vehicle using a data logger. It pertains to a device and method for sensing various physical quantities in the land transport environment and detecting various factors in land distribution that influence the transport environment.

Furthermore, the present disclosure relates to a system and method for analyzing the deviation between the predicted and actual routes of a vehicle, calculating the causes and impact of the deviation, and optimizing the land transport route of the vehicle.

### BACKGROUND OF THE RELATED ART

With advancements s in technology and industry, distribution networks are expanding, making the storage and transportation conditions of goods during distribution processes increasingly crucial. Particularly, in the transportation of high-value products such as large-capacity batteries, exposure to high temperatures, vibrations, and humidity can result in product damage. In such cases, it is not just a single product that may be affected, but other products stored in the same space and environment may also suffer damage in a cascading manner.

High-value products require a different logistics and transportation environment than low-value products. In logistics management, ensuring that transported goods are not damaged or lost is of utmost importance. With technological advancements, various devices and methods for efficient logistics management have been applied. However, even for high-value products, there remains a problem in monitoring product deterioration and damage due to high temperatures, vibrations, and humidity during transport, necessitating the introduction of a more efficient and systematic transport quality management system.

### SUMMARY OF THE INVENTION

The embodiments disclosed herein aim to prevent sudden acceleration or deceleration of a vehicle, preemptively detect impacts on cargo, thereby preventing accidents, protecting cargo stored in the cargo compartment, ensuring the safe delivery of protected cargo to consumers, clearly defining the responsibilities of cargo owners and logistics providers in cases where cargo condition changes due to internal temperature variations, and establishing a system that provides a stable land transport environment.

Additionally, the disclosed embodiments aim to establish a system for analyzing the deviation between the predicted and actual routes of a vehicle and optimizing the land transport route of the vehicle.

The problems intended to be solved by the present disclosure are not limited to those mentioned above, and additional problems not explicitly stated will be apparent to those skilled in the art from the following description.

To achieve the above-described technical objectives, an aspect of the present disclosure provides a device for sensing and processing the land transport environment of a vehicle, including an inertial sensor that senses impacts on cargo stored in the cargo compartment due to sudden acceleration or deceleration of the vehicle, a processor that calculates a second frequency to offset a first frequency corresponding to the impact sensed by the inertial sensor and outputs a control signal including the second frequency, and a vibration generator that vibrates at the second frequency in response to the control signal.

Another aspect of the present disclosure provides a method for sensing and processing the land transport environment of a vehicle, which includes a sensing step of sensing impacts on cargo stored in the cargo compartment due to sudden acceleration or deceleration, a calculation step of computing a second frequency to offset a first frequency corresponding to the sensed impact, a vibration step of vibrating at the second frequency, and a determination step of analyzing causes of temperature variations based on externally received temperature data.

Furthermore, a computer-readable recording medium storing a computer program for executing the method to implement the present disclosure may be provided.

Additionally, a computer program stored in a recording medium may be provided to execute the method by being combined with hardware to implement the present disclosure.

To achieve the above-described technical objectives, another aspect of the present disclosure provides a system for optimizing the land transport route of a transport means, including a tracker installed in the transport means that senses transport environment data, including the environment of cargo contained in the transport means, and transmits the transport environment data, a server that analyzes the deviation between the predicted and actual transport routes based on the transport environment data, calculates an impact index indicating the extent to which the deviation affects the cargo, and optimizes the transport route based on the deviation and impact index, and a transport database established for transport route optimization.

Another aspect of the present disclosure provides a method for optimizing the land transport route of a transport means, which includes a sensing step of sensing transport environment data, including the environment of cargo contained in the transport means, an analysis and calculation step of analyzing the deviation between the predicted and actual transport routes and calculating an impact index indicating the extent to which the deviation affects the cargo based on the transport environment data, and a route optimization step of optimizing the transport route based on the deviation and impact index.

Furthermore, a computer-readable recording medium storing a computer program for executing the method to implement the present disclosure may be provided.

Additionally, a computer program stored in a recording medium may be provided to execute the method by being combined with hardware to implement the present disclosure.

According to the means for solving the problems described in the present disclosure, it provides the effects of preventing sudden acceleration or deceleration of a vehicle, preemptively detecting impacts on cargo to prevent accidents, protecting cargo stored in the cargo compartment, safely delivering protected cargo to consumers, providing convenience and satisfaction to consumers, clearly defining the responsibilities of cargo owners and logistics providers in cases where cargo condition changes due to internal temperature variations, and establishing a stable land transport environment.

Furthermore, by providing an advanced route optimization solution, it enables route planners to manage vehicles, monitor driving routes, add multiple stops, improve productivity, and enhance compliance with service level agreements (SLA). Additionally, route optimization reduces fuel costs, enables additional pickup/delivery stops, lowers labor overtime costs, and minimizes human dependency.

The effects of the present disclosure are not limited to the mentioned advantages, and additional effects not explicitly stated will be apparent to those skilled in the art from the following description.

### BRIEF DESCRIPTION OF THE DRAWINGS

FIGS. 1a and 1b illustrate an exemplary system of the present disclosure.

FIGS. 2 and 3 illustrate an exemplary tracker of the present disclosure.

FIGS. 4a and 4b illustrate another exemplary tracker of the present disclosure.

FIG. 5 is a flowchart illustrating an example of sensing and mitigating vibration caused by impact.

FIG. 6 is a diagram illustrating an example of offsetting vibrations occurring in the cargo compartment.

FIG. 7 is a graph illustrating patterns of temperature variations over time.

FIG. 8 is a diagram illustrating pattern data.

FIG. 9 is a diagram illustrating flag data.

FIG. 10 is a diagram illustrating an example of setting sensing areas based on frequent cargo compartment door openings.

FIG. 11 is a diagram illustrating areas with frequent temperature variations and areas with minimal temperature changes.

FIG. 12 is a flowchart illustrating the method of the present disclosure.

FIGS. 13a, 13b, and 13c illustrate an exemplary system of the present disclosure.

FIGS. 14 and 15 illustrate an exemplary tracker of the present disclosure.

FIG. 16 is a flowchart illustrating an example of transport route optimization.

FIG. 17 is a flowchart illustrating an example of generating alerts for temperature and humidity variations.

FIG. 18 is a flowchart illustrating an example of generating alerts for impact events.

FIG. 19 is a flowchart illustrating another example of transport route optimization.

FIG. 20 is a flowchart illustrating yet another example of transport route optimization.

FIG. 21 is a flowchart illustrating an example of analyzing causes of deviations in alternative transport routes.

FIG. 22 is a flowchart illustrating an example of calculating correlations and weights among microscopic factors.

FIG. 23 is a flowchart illustrating the method of the present disclosure.

### DETAILED DESCRIPTION OF THE PREFERRED EMBODIMENT

Throughout this disclosure, identical reference numerals denote identical components. This disclosure does not describe all elements of the embodiments, and general technical details or overlapping content between embodiments are omitted. The terms “unit,” “module,” “member,” and “block,” as used in the specification, may be implemented in either software or hardware. Depending on the embodiment, multiple “units, modules, members, or blocks” may be implemented as a single component, or a single “unit, module, member, or block” may include multiple components.

Throughout the specification, when a component is described as being “connected” to another component, this includes both direct and indirect connections, where indirect connections may include connections via a wireless communication network. Additionally, when a component is described as “including” another component, unless explicitly stated otherwise, this does not exclude other components but rather implies that additional components may also be included.

Throughout the specification, when a component is described as being “on” another component, this includes cases where the component is in direct contact with the other component as well as cases where an additional component exists between the two.

The terms “first,” “second,” etc., are used to distinguish one component from another and do not impose any particular limitations on the components.

Singular expressions include plural expressions unless explicitly stated otherwise in the context.

In the description of procedural steps, identifiers are used for convenience but do not necessarily indicate the sequence of execution. Unless a specific order is explicitly mentioned in the context, the steps may be executed in a different order.

The following describes the operational principles and embodiments of the present disclosure with reference to the accompanying drawings.

### 1. Embodiment 1

The following embodiment describes a device and method for sensing and processing a leading vehicle's land transportation environment.

In this specification, “a device according to the present disclosure” includes various devices capable of performing computational processing to provide results to a user. For example, the device may encompass computers, server devices, and portable terminals, either individually or collectively.

Examples of computers include laptops, desktops, tablets, and slate PCs equipped with a web browser.

Server devices include application servers, computing servers, database servers, file servers, game servers, mail servers, proxy servers, and web servers, which process information through communication with external devices.

Portable terminals refer to wireless communication devices ensuring portability and mobility, such as PCS (Personal Communication System), GSM (Global System for Mobile Communications), PDC (Personal Digital Cellular), PHS (Personal Handyphone System), PDA (Personal Digital Assistant), IMT-2000 (International Mobile Telecommunication-2000), CDMA-2000 (Code Division Multiple Access-2000), W-CDMA (Wideband Code Division Multiple Access), WiBro (Wireless Broadband Internet) devices, and smartphones. Additionally, wearable devices such as watches, rings, bracelets, anklets, necklaces, glasses, contact lenses, and head-mounted devices (HMDs) may also be included.

The artificial intelligence-related functionalities according to the present disclosure operate via a processor and memory. The processor may consist of one or multiple processors. These may include general-purpose processors such as CPU, AP, and DSP (Digital Signal Processor), graphics-specific processors such as GPU and VPU (Vision Processing Unit), or AI-dedicated processors such as NPU. One or more processors control the processing of input data based on predefined operational rules stored in memory or according to an artificial intelligence model. If the processor is an AI-specific processor, it may be designed with a specialized hardware architecture optimized for processing specific AI models. Examples of processors include MCUs (Microcontroller Units), fan control actuators, and APUs (Accelerated Processing Units).

The predefined operational rules or AI models are characterized by being trained through learning. Here, learning refers to the process by which a basic AI model is trained using multiple learning datasets through learning algorithms, thereby creating predefined operational rules or AI models that perform desired functions. Such learning may occur within the device executing the AI or be performed via a separate server and/or system. Examples of learning algorithms include supervised learning, unsupervised learning, semi-supervised learning, and reinforcement learning, but are not limited to these.

An AI model may consist of multiple neural network layers, each of which has multiple weight values. The neural network computation is performed through operations between the weight values and the results of the previous layer. The weight values of multiple neural network layers may be optimized based on the training results of the AI model. For instance, during the training process, the AI model updates weight values to minimize or reduce the loss (loss value) or cost (cost value). The artificial neural network may include a deep neural network (DNN), such as CNN (Convolutional Neural Network), DNN (Deep Neural Network), RNN (Recurrent Neural Network), RBM (Restricted Boltzmann Machine), DBN (Deep Belief Network), BRDNN (Bidirectional Recurrent Deep Neural Network), or deep Q-networks (Deep Q-Networks), but is not limited to these.

According to an exemplary embodiment of the present disclosure, the processor may implement artificial intelligence. Artificial intelligence refers to a machine learning technique based on artificial neural networks that mimic biological neurons to enable machines to learn. AI methodologies are classified by learning method into supervised learning (where input and output data are both provided and the answer is predefined), unsupervised learning (where only input data is provided and the answer is undefined), and reinforcement learning (where an external environment provides rewards for actions taken, and learning is carried out to maximize these rewards). Furthermore, AI methodologies may also be categorized based on the architecture of the learning model. Popular deep learning architectures include convolutional neural networks (CNN), recurrent neural networks (RNN), transformers, and generative adversarial networks (GAN).

The device and system described herein may include an artificial intelligence (AI) model. The AI model may be a single AI model or may be implemented using multiple AI models. The AI model may be configured as a neural network (or artificial neural network) and may incorporate statistical learning algorithms that mimic biological neural structures in the fields of machine learning and cognitive science. A neural network may broadly refer to a model in which artificial neurons (nodes) form a network through synaptic connections, and the strength of these connections changes through learning, thereby enabling problem-solving capabilities. The neurons in a neural network may include a combination of weights or biases. The neural network may comprise one or more layers consisting of one or more neurons or nodes. For example, the device may include an input layer, a hidden layer, and an output layer. The neural network that constitutes the device may modify the weights of its neurons through learning, thereby inferring the desired output from an arbitrary input.

The processor may generate a neural network, train (or learn) the neural network, perform computations based on received input data, generate an information signal based on the computation results, or retrain the neural network. The neural network models may include various types such as CNN (Convolutional Neural Network), R-CNN (Region with Convolutional Neural Network), RPN (Region Proposal Network), RNN (Recurrent Neural Network), S-DNN (Stacking-based Deep Neural Network), S-SDNN (State-Space Dynamic Neural Network), Deconvolution Network, DBN (Deep Belief Network), RBM (Restricted Boltzmann Machine), Fully Convolutional Network, LSTM (Long Short-Term Memory) Network, and Classification Network, among others, such as GoogleNet, AlexNet and VGG Network. However, the models are not limited thereto. The processor may include one or more processors configured to perform computations based on the neural network models. For example, the neural network may include a deep neural network (DNN).

The neural network may include, but is not limited to, CNN (Convolutional Neural Network), RNN (Recurrent Neural Network), Perceptron, Multilayer Perceptron (MLP), Feed Forward (FF), Radial Basis Network (RBF), Deep Feed Forward (DFF), Long Short-Term Memory (LSTM), Gated Recurrent Unit (GRU), Auto Encoder (AE), Variational Auto Encoder (VAE), Denoising Auto Encoder (DAE), Sparse Auto Encoder (SAE), Markov Chain (MC), Hopfield Network (HN), Boltzmann Machine (BM), Restricted Boltzmann Machine (RBM), Deep Belief Network (DBN), Deep Convolutional Network (DCN), Deconvolutional Network (DN), Deep Convolutional Inverse Graphics Network (DCIGN), Generative Adversarial Network (GAN), Liquid State Machine (LSM), Extreme Learning Machine (ELM), Echo State Network (ESN), Deep Residual Network (DRN), Differentiable Neural Computer (DNC), Neural Turing Machine (NTM), Capsule Network (CN), Kohonen Network (KN), and Attention Network (AN). However, a person skilled in the art would understand that any neural network may be included without being limited to these examples.

According to an exemplary embodiment of the present disclosure, the processor may utilize various AI architectures and algorithms, including CNN (Convolutional Neural Network), R-CNN (Region with Convolutional Neural Network), RPN (Region Proposal Network), RNN (Recurrent Neural Network), S-DNN (Stacking-based Deep Neural Network), S-SDNN (State-Space Dynamic Neural Network), Deconvolution Network, DBN (Deep Belief Network), RBM (Restricted Boltzmann Machine), Fully Convolutional Network, LSTM (Long Short-Term Memory) Network, Classification Network, Generative Modeling, explainable AI, Continual AI, Representation Learning, AI for Material Design, and natural language processing (NLP) models such as BERT, SP-BERT, MRC/QA, Text Analysis, Dialog System, GPT-3, and GPT-4. It may also include vision processing techniques such as Visual Analytics, Visual Understanding, Video Synthesis, ResNet, and data intelligence techniques such as Anomaly Detection, Prediction, Time-Series Forecasting, Optimization, Recommendation, and Data Creation. However, the processor is not limited to these examples.

Hereinafter, the exemplary embodiments of the present disclosure will be described in detail with reference to the accompanying drawings.

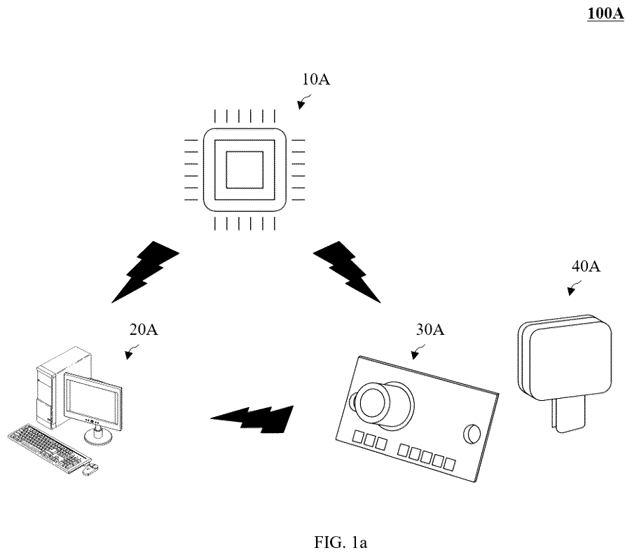

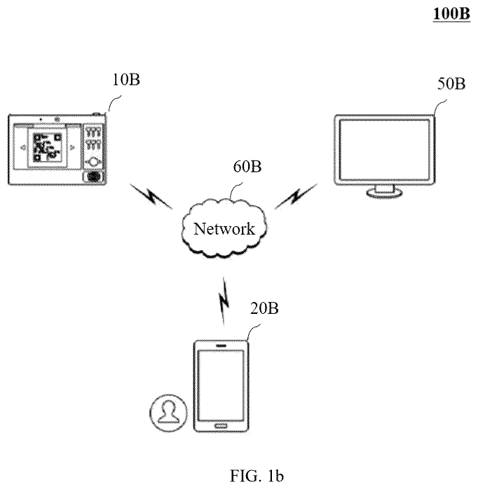

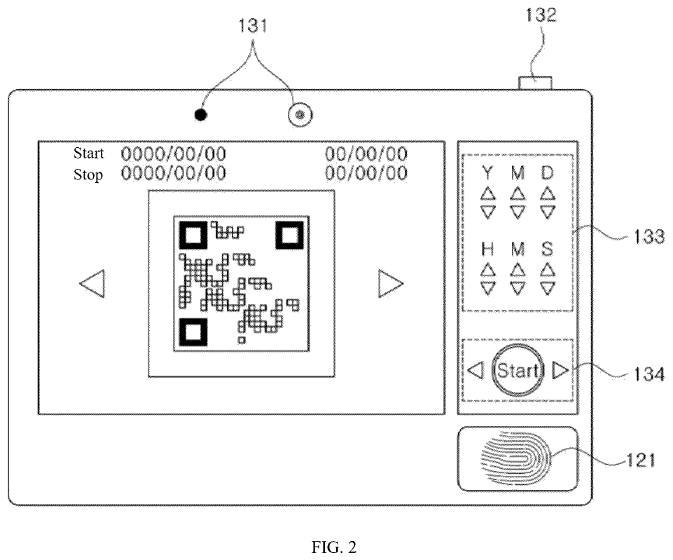

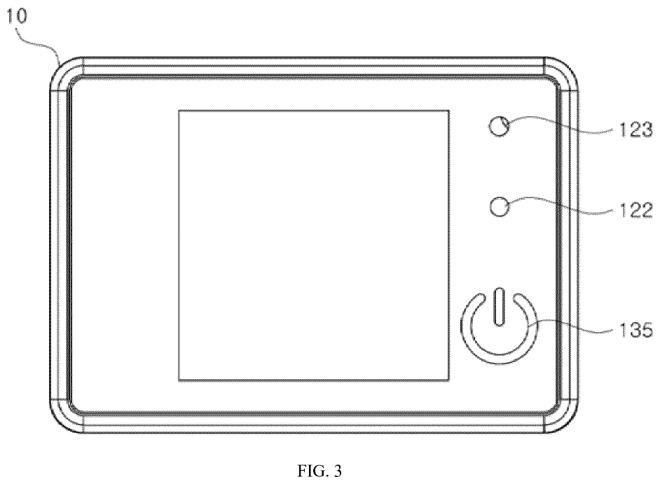

FIGS. 1a and 1b illustrate an exemplary system of the present disclosure. FIGS. 2 and 3 illustrate an exemplary tracker according to the present disclosure. FIG. 2 is a front view of the tracker, and FIG. 3 is a rear view of the tracker.

Referring to FIG. 1a, to perform the operations of the present disclosure, a tracker 10A for the cargo transport space, a user terminal 20A, a temperature measurement sensor 30A, and a distance measurement sensor 40A may be provided.

The tracker 10A may include various devices capable of performing computation and providing results to the user.

The user terminal 20A may include both computers and portable user terminals or may be in any one form. Here, the computer may include, for example, a notebook, desktop, laptop, tablet PC, or slate PC equipped with a web browser.

The device (server) may be a server that processes information by communicating with external devices and may include an application server, computing server, database server, file server, game server, mail server, proxy server, and web server.

A portable user terminal may be, for example, a wireless communication device that ensures portability and mobility, including all types of handheld-based wireless communication devices such as PCS (Personal Communication System), GSM (Global System for Mobile Communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), WiBro (Wireless Broadband Internet) terminals, and smartphones (Smart Phones). Additionally, it may include wearable devices such as watches, rings, bracelets, anklets, necklaces, glasses, contact lenses, or head-mounted devices (HMD).

The temperature measurement sensor 30A may be attached inside the cargo transport space (e.g., inside the cargo). The temperature measurement sensor 30A may be attached to a predetermined location designated by the user. It senses the temperature and humidity inside the cargo and outputs the sensed information to the tracker 10A.

The distance measurement sensor 40A may be attached inside the cargo transport space and generate distance data by measuring the distance between multiple first locations predetermined by the user and multiple second locations, which are the remaining vertex positions where the temperature measurement sensor 30A is not attached. The distance measurement sensor 40A may include one of a Lidar sensor, an ultrasound sensor, a short/medium-range radar sensor, a long-range radar sensor, and cameras.

Referring to FIG. 1b, the system 100B may include a tracker 10B, a first user terminal 20B, a second user terminal 50B, and a communication network 60B. While FIG. 1 illustrates the number of user terminals as two, this is not a limitation; there may be one, or three or more.

The tracker 10B may be a device for sensing and compensating for the land transport environment of a vehicle. The vehicle may include automobiles, motorcycles, trucks, and trains. In one embodiment, the vehicle may be a train with at least one cargo compartment or a train connected to at least one cargo compartment, but it is not limited thereto. The tracker 10B may communicate with the first and second user terminals 20B, 50B via the communication network 60B. The tracker 10B includes various devices capable of performing computational processing and providing results to the user. For example, the tracker 10B may include a computer, a device (server), or a portable terminal, or may take one of these forms. Here, the computer may include, for example, a laptop, desktop, laptop computer, tablet PC, or slate PC equipped with a web browser. The device (server) may be a server that processes information through communication with external devices, including application servers, computing servers, database servers, file servers, game servers, mail servers, proxy servers, and web servers.

Referring to FIG. 2, the front side of the tracker (10B) may be equipped with a sensing unit 131, a switch 132, input sections 133, 134, a fingerprint recognition button 121, and a display. The user may enter a start and end date through the input section 133 displayed on the display. Referring to FIG. 3, the rear side of the tracker 10B may include various buttons 122, 123 and a power indicator 135. The input unit is for receiving information from the user, allowing information to be entered through the user input section. The user input section may include hardware-based physical keys (e.g., buttons, dome switches, jog wheels, jog switches located on at least one of the front, rear, or side of the device) and software-based touch keys. For example, the touch keys may consist of virtual keys, soft keys, or visual keys displayed on a touchscreen-based display through software processing or touch keys arranged outside the touchscreen area. The virtual or visual keys may take various forms and be displayed on the touchscreen, for example, as graphics, text, icons, videos, or combinations thereof.

Referring to FIG. 1b, the first user terminal 20B and the second user terminal 50B may include both the aforementioned computer and portable user terminal or may take one of these forms. A portable user terminal may be, for example, a wireless communication device that ensures portability and mobility, including all types of handheld-based wireless communication devices such as PCS, GSM, PDC, PHS, PDA, IMT-2000, CDMA-2000, W-CDMA, WiBro terminals, smartphones, and wearable devices such as watches, rings, bracelets, anklets, necklaces, glasses, contact lenses, or head-mounted devices (HMD).

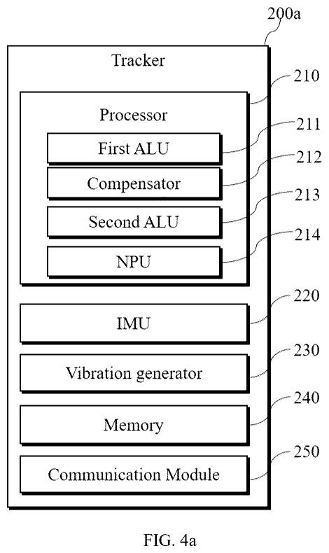

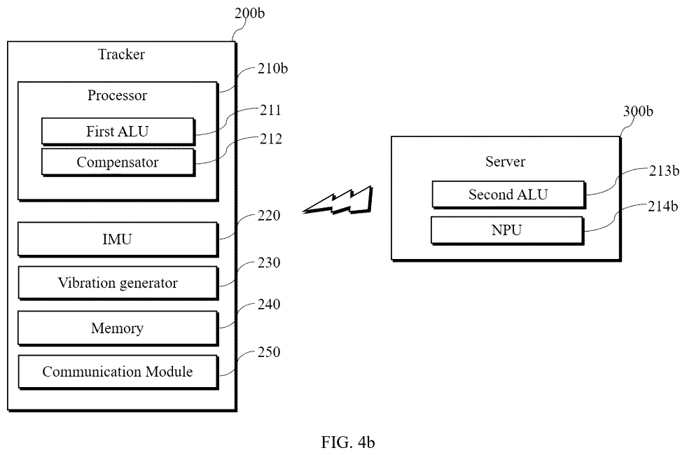

FIGS. 4a and 4b illustrate examples of trackers disclosed herein.

Referring to FIG. 4a, the tracker 200a may be a device for sensing and processing the land transport environment of a vehicle. For example, the vehicle may be a train equipped with a cargo compartment, and the tracker 200a may be installed inside the train and/or the cargo compartment to sense and process the land transport environment, temperature and/or humidity. The tracker 200a may include a processor 210, an inertial sensor 220, a vibration generator 230, memory 240, and a communication module 250.

The processor 210 may calculate a second frequency to offset the first frequency corresponding to an impact sensed by the inertial sensor 220. The processor 210 may output a control signal including the second frequency. The control signal may be input to the vibration generator 230. This function aims to prevent rapid acceleration or deceleration of the vehicle, detect shocks affecting the cargo due to such movements, indirectly enforce safe driving in the distribution stage, and mitigate vibrations caused by friction between the vehicle and the tracks. Accordingly, this enables the prevention of rapid acceleration or deceleration of the vehicle, early detection of shocks affecting the cargo to prevent safety incidents, protection of cargo within the cargo compartment, and the safe and stable delivery of protected cargo to consumers, thereby enhancing consumer convenience and satisfaction.

Additionally, the processor 210 may receive temperature data from external sources. For example, the processor 210 may receive temperature data from the temperature measurement sensor 30A of FIG. 1a. In this case, the temperature measurement sensor 30A may be installed inside the cargo compartment, measuring the internal temperature and transmitting the temperature data to the processor 210. The processor 210 may monitor the temperature over time and check it at predetermined time intervals. Based on the received temperature data, the processor 210 may determine the cause of temperature variations inside the compartment. For example, the cause of temperature variation may be air circulation due to the opening or closing of the cargo compartment door by a user (e.g., transporter, cargo owner), allowing external air to enter the compartment and internal air to exit. Alternatively, the cause may be temperature fluctuations due solely to external environmental factors such as weather or travel routes when the compartment door remains closed. By identifying the cause of internal temperature variations of the cargo compartment, the processor 210 enables the determination of responsibility between the cargo owner and logistics party regarding any damage to the cargo due to temperature changes.

In one embodiment, the processor 210 may include a first computation unit 211 and a correction unit 212.

The first computation unit 211 may perform various calculations within the processor 210. In one embodiment, the first computation unit 211 may be implemented as an arithmetic logic unit (ALU: Arithmetic and Logical Unit), but is not limited thereto. The first computation unit 211 may calculate the phase of each first signal that causes shocks sensed by the inertial sensor 220. The shocks sensed by the inertial sensor 220 may have a first frequency, which may be a combination of the frequencies of at least one first signal.

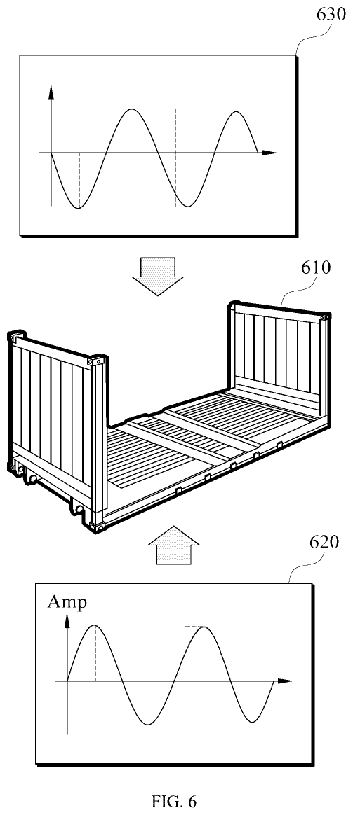

The correction unit 212 can generate second signals, each having a phase opposite to that of the respective first signals. The first and second signals will be described later with reference to FIG. 6. The correction unit 212 can output control signals, including the second signals, to the vibration generator.

In one embodiment, the processor 210 may further include a second computing unit 213. The second computing unit 213 can identify patterns in temperature variations based on temperature data received from an external source. For example, the second computing unit 213 can receive temperature data through the communication module 250 and analyze time-based temperature variations included in the data to detect patterns. By analyzing these patterns, the second computing unit 213 determines whether the temperature variations result from external environmental factors or the intervention of a transporter, thereby diagnosing the cause of the temperature variations. The second computing unit 213 can generate cause data that includes information on the reason for the temperature variations.

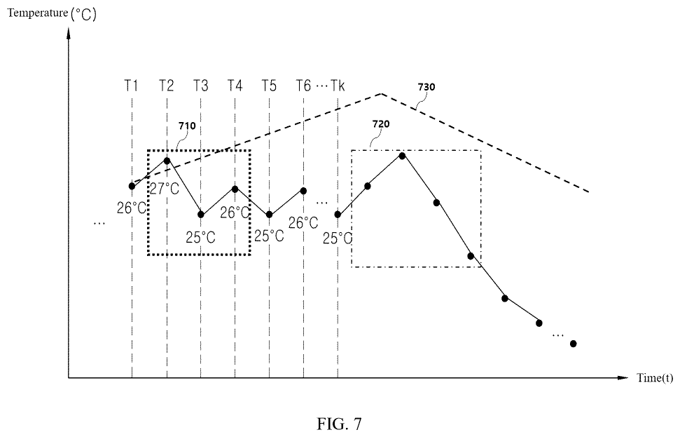

Depending on the embodiment, the second computing unit 213 can estimate a trend line representing the trend of temperature changes over time based on the temperature data and cause data. The trend line will be described later with reference to FIG. 7.

Additionally, the second computing unit 213 can control the memory 240 to store the cause data. Similar to the first computing unit 211, the second computing unit 213 can be implemented as an ALU.

In different embodiments, the first computing unit (211) and the second computing unit 213 may be implemented as separate hardware components or as an integrated computing unit capable of performing the operations and functions of both.

In one embodiment, the processor 210 may further include an artificial neural network processing unit 214. The artificial neural network processing unit 214 can generate an artificial intelligence model and train it. The artificial intelligence model can learn from a training dataset that includes first data, which consists of a series of sequential temperature points over time, and second data, which includes pattern identifiers representing a graph connecting these points. The artificial neural network processing unit 214 can evaluate the performance of the artificial intelligence model based on training results. And the artificial neural network processing unit 214 can tune or fit an artificial intelligence model according to the performance of the artificial intelligence model.

In this disclosure, the artificial neural network processing unit 214 may be separately provided on a printed circuit board constituting the tracker 200a or may operate logically as an execution module within the processor chipset. For example, the artificial neural network processing unit 214 can be stored as program code in memory 240, fetched by the processor 210, and sequentially interpreted to implement a machine learning model trained for a specific purpose.

Depending on the embodiment, the second computing unit 213 can input data containing points into the artificial intelligence model. Furthermore, the second computing unit 213 can predict pattern identifiers as output data of the artificial intelligence model. The second computing unit 213 can also receive pattern data from the memory 240 and identify patterns by searching for a matching pattern identifier among multiple pattern identifiers included in the pattern data.

The inertial sensor 220 can sense impacts on cargo contained in a vehicle's cargo compartment due to rapid acceleration or deceleration. The inertial sensor 220 can measure the vehicle's roll, vibrations, and/or impacts applied to the vehicle. It can detect the vehicle's motion based on a 6-degree-of-freedom (6DoF) or 9-degree-of-freedom (9DoF) system. The inertial sensor 220 may be used for cargo sensitive to shocks and vibrations, such as industrial equipment, to prevent excessive acceleration or deceleration. The inertial sensor 220 can be implemented as an inertial measurement unit (IMU).

In one embodiment, the inertial sensor 220 can detect the natural frequency of cargo vibration due to vertical oscillation within a unit time caused by the vehicle's acceleration and inertial direction. The first computing unit (211) can then calculate the phase of each first signal based on the vehicle's acceleration and the cargo's mass. The correction unit 212 can generate second signals with the same natural frequency and amplitude but with opposite phases.

The vibration generator 230 can vibrate at a second frequency in response to the control signals. In one embodiment, the vibration generator 230 may include a haptic module for generating vibrations or a sonic module for emitting sound waves.

The memory 240 can store data supporting various functions of the tracker 200a and programs for the operation of the processor 210. It can also store input/output data (e.g., music files, still images, videos), multiple application programs running on the tracker 200a, and data or instructions required for tracker 200a) operation. Some of these applications may be downloaded from an external server via wireless communication. The memory 240 may include at least one type of storage medium, such as flash memory, hard disk, solid-state disk (SSD), silicon disk drive (SDD), multimedia card micro type, card-type memory (e.g., SD or XD memory), RAM, static RAM (SRAM), read-only memory (ROM), electrically erasable programmable ROM (EEPROM), programmable ROM (PROM), magnetic memory, magnetic disk, or optical disk.

The memory 240 in one embodiment can store pattern data and flag data. The pattern data may include characteristics of a plurality of predetermined patterns and a plurality of pattern identifiers representing each of the patterns. The characteristics of a pattern may visually represent the pattern's shape or describe its shape in text, for example. The pattern identifier may be expressed in numbers, characters, or a combination of both. The flag data may include a flag for each pattern, and if there are multiple patterns, the number of flags may also be multiple. For instance, the flag data may include a flag for the first pattern, a flag for the second pattern, and a flag for the third pattern. The flag can indicate whether the cause of a pattern identifier is due to external environmental factors or the intervention of a transporter. For example, if the cause of temperature change is due to external environmental factors (e.g., route changes, weather-related force majeure), the flag may have a first value (e.g., ‘1’). If the cause of the temperature change is due to the intervention of a transporter (e.g., opening or closing of the cargo compartment door), the flag may have a second value (e.g., ‘0’). However, the flag values are not limited to these examples and may be set differently depending on the embodiment.

Meanwhile, the second computing unit 213 can load pattern data and flag data from the memory 240. It can extract characteristics of a pattern to be identified based on sequential temperature values over time from the temperature data. For instance, the second computing unit 213 can compute the pattern's shape using points containing temperature values over time. Then, based on the extracted characteristics of the pattern and the pattern data, it can obtain the pattern identifier of the pattern to be identified. Specifically, by extracting pattern characteristics (e.g., shape) matching the computed pattern shape from the pattern data, second computing unit 213 can acquire the pattern identifier of the pattern to be identified. Furthermore, based on the obtained pattern identifier and the flag data, it can diagnose the cause. For example, by reading the specific flag value corresponding to the acquired pattern identifier in the flag data, the cause can be diagnosed.

The communication module 250 can perform a communication interface, which may include one or more components that enable communication with external devices. For instance, the communication interface may include at least one of a wired communication module, a wireless communication module, or a short-range communication module. The wired communication module can include various wired communication modules such as a Local Area Network (LAN) module, a Wide Area Network (WAN) module, or a Value-Added Network (VAN) module. Additionally, it may support various cable communication modules, including USB (Universal Serial Bus), HDMI (High Definition Multimedia Interface), DVI (Digital Visual Interface), RS-232 (Recommended Standard 232), power line communication, or POTS (Plain Old Telephone Service).

The wireless communication module may support various wireless communication methods, including Wi-Fi, Wireless Broadband (WiBro), GSM (Global System for Mobile Communication), CDMA (Code Division Multiple Access), WCDMA (Wideband Code Division Multiple Access), UMTS (Universal Mobile Telecommunications System), TDMA (Time Division Multiple Access), LTE (Long Term Evolution), 4G, 5G, and 6G. The wireless communication module may include a wireless communication interface containing an antenna and a transmitter for transmitting signals. It may also include a signal conversion module that modulates digital control signals output from the processor 210 into analog wireless signals, under the control of the processor 210.

The short-range communication module may support short-range communication (Short Range Communication) using at least one of Bluetooth™, RFID (Radio Frequency Identification), Infrared Data Association (IrDA), UWB (Ultra-Wideband), ZigBee, NFC (Near Field Communication), Wi-Fi Direct, and Wireless USB (Wireless Universal Serial Bus).

In one embodiment, the communication module 250 can receive temperature data from an external temperature measurement sensor 30A and transmit the received temperature data to the processor 210.

Additionally, the communication module 250 can transmit cause data to an external device via a communication network. The external device may include, for example, a user terminal 20A, a first user terminal 20B, and/or a second user terminal 50B.

Referring to FIG. 4B, the tracker 200b may include a processor 210b, an inertial sensor 220, a vibration generator 230, a memory 240, and a communication module 250. The processor 210b may include a first computing unit 211 and a correction unit 212. The server 300b may include a second computing unit 213b and an artificial neural network processing unit 214b. The server 300b may directly create an artificial neural network, train the neural network, provide trained results and hyperparameters to the tracker 200b, or allow the tracker 200b to store predetermined values as firmware in the memory 240 or processor 210b).

In one embodiment, the processor 210b can store program code corresponding to the artificial neural network processing unit in the memory 240) or load it as firmware into the processor 210b to perform corresponding functions. In this disclosure, the artificial neural network processing unit may be an operational module that logically operates inside the processor 210b chipset. For example, the artificial neural network processing unit may be stored as program code in the memory 240, and when fetched and sequentially interpreted by the processor 210b, it may function to implement a trained machine learning model.

The server 300b may be provided outside the transportation environment. For example, the server 300b may be a server that processes information by communicating with external devices and may include an application server, a computing server, a database server, a file server, a game server, a mail server, a proxy server, a cloud server, and a web server. In this case, the artificial neural network processing unit 213b may train large-scale machine learning models in the server environment or compute hyperparameter values that minimize the loss function of trained models.

The tracker 200b can store the machine learning model and hyperparameter values computed by the server 300b in the memory 130b. By interpreting the program code for running the machine learning model, the processor 210b can effectively derive computing results that are equivalent to the inference values of the artificial neural network in a fast and lightweight manner.

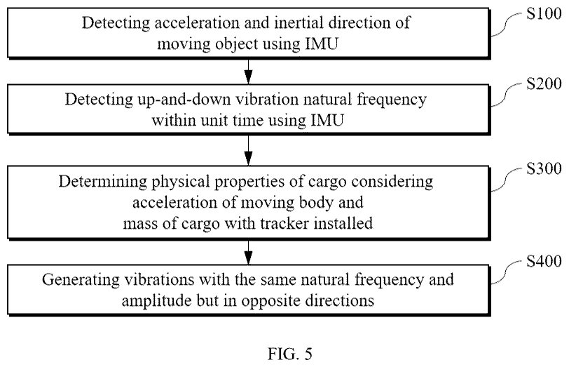

The flowchart in FIG. 5 exemplarily illustrates an embodiment of the present disclosure for sensing and mitigating vibrations caused by impact.

Referring to FIGS. 1, 2, and 5, in step S100, tracker 10A detects the acceleration and inertial direction of the moving body using an IMU. For example, as shown in FIG. 2, the inertial sensor 220 can sense the acceleration and inertial direction of the vehicle.

In step S200, tracker 10A detects the natural frequency of the vehicle vibrating up and down per unit time using the IMU. Referring to FIG. 2, for example, as the vehicle or cargo compartment moves vertically, the cargo contained within the cargo compartment may also move vertically, and the inertial sensor 220 can sense the frequency generated by the vertical movement of the cargo. More specifically, the inertial sensor 220 can sense the natural frequency caused by the vertical vibration of the cargo per unit time due to the vehicle's acceleration and inertial direction.

In step S300, tracker 10A determines the physical properties of the cargo by considering the acceleration of the moving body and the mass of the cargo. In step S400, tracker 10A generates vibrations with the same natural frequency and amplitude but in the opposite direction. For example, the first calculation unit 211, based on the physical properties of the cargo determined from the vehicle's acceleration and cargo mass, can calculate the phase of each first signal. The compensation unit 212 can generate second signals with the same natural frequency and amplitude but opposite phase. The vibration generator 230 can generate vibrations corresponding to the second signals.

FIG. 6 exemplarily illustrates an embodiment of the present disclosure for canceling vibrations occurring in the cargo compartment.

Referring to FIG. 6, external impacts, such as vibrations from road surfaces or tracks, can be transmitted to the cargo compartment 610, causing it to vibrate vertically at its natural frequency. When the vibration of the cargo compartment 610 is detected, the first signal 620 can be measured. The first signal 620 may have a first natural frequency and a first amplitude. Meanwhile, the device of the present disclosure can generate a second signal 630 to cancel out the first signal 620. The second signal 630 may have a second natural frequency and a second amplitude. The first and second natural frequencies can be the same, while the first and second amplitudes may have the same magnitude but opposite signs (or phases). By combining the first signal 620 and the second signal 630, the vibration of the cargo compartment 610 can be canceled, thereby providing a stable land transport environment.

FIG. 7 exemplarily illustrates a graph showing the temperature variation pattern over time.

Referring to FIG. 7, in the graph, the horizontal axis represents time (T), and the vertical axis represents temperature (° C.). While the temperature unit is Celsius, it is not limited thereto and may also be in Fahrenheit or other units. Assuming that at time T1, the internal temperature is 26° C.; at time T2, it is 27° C.; at time T3, it is 25° C.; at time T4, it is 26° C.; at time T5, it is 25° C.; at time T6, it is 26° C.; and at time Tk, it is 25° C., where k is a natural number equal to or greater than 6.

A graph can be formed connecting points consisting of T2 time and internal temperature (27° C.), T3 time and internal temperature (25° C.), and T4 time and internal temperature (26° C.). The graph connecting the points at each of T2, T3, and T4 can be identified as a pattern 710. Although FIG. 7 shows three points used to determine pattern 710, the number of points is not limited thereto. Pattern 710 may represent temperature changes caused by human intervention, such as when a transporter opens or closes the cargo compartment door.

In a similar manner to pattern 710, a graph can be formed connecting points consisting of times after time Tk and internal temperatures at each of times after time Tk, and the graph can be identified as pattern 720. Pattern 720 may represent temperature fluctuations due to external environmental factors rather than human intervention.

A trend line 730, which estimates the expected temperature changes without door openings, can be derived through estimation and fitting. The trend line 730 represents the predicted graph when there is no door opening.

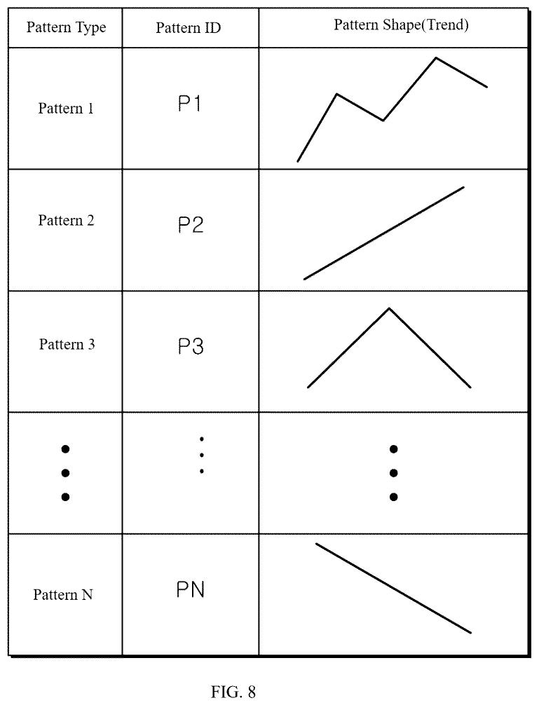

FIG. 8 exemplarily illustrates pattern data.

Referring to FIG. 8, in an embodiment, pattern data may include a pattern type, a pattern identifier, and a pattern shape. The pattern type may include, for example, a first pattern to an N-th pattern, where N is a natural number equal to or greater than 2. The pattern identifier may include, for example, P1 to PN. The pattern shape may vary, such as a straight line or a broken line, as shown in FIG. 8.

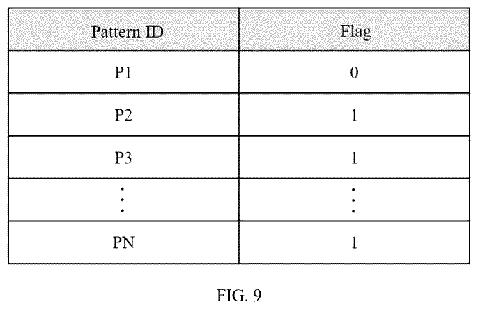

FIG. 9 exemplarily illustrates flag data.

Referring to FIGS. 8 and 9, in an embodiment, flag data may include a pattern identifier and a flag. The flag represents the value matched to each pattern identifier. For example, if the pattern identifier is P1, the flag value may be “0.” If the pattern identifier is P2, P3, or PN, the flag value may be “1.” The flag value of “0” may indicate that the temperature change is due to human intervention, whereas a flag value of “1” may indicate that the temperature change is due to external environmental factors. However, the meaning assigned to flag values is not limited to this example and may be designed oppositely.

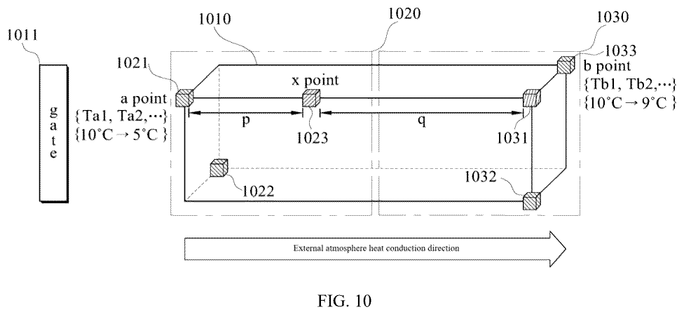

FIG. 10 exemplarily illustrates an embodiment of setting a sensing area in response to frequent door openings in the cargo compartment.

Referring to FIG. 10, the door 1011 of the cargo compartment 1010 can be opened and closed. When the door 1011 of the cargo compartment 1010 is opened, the external temperature can propagate into the interior of the cargo compartment 1010 in the direction exemplarily illustrated in FIG. 10. Depending on the frequency of opening and closing of the door 1011 of the cargo compartment 1010, zones for precisely sensing internal temperature, vibrations, and other conditions can be designated. For instance, a first zone 102 and a second zone 1030) may be set within the cargo compartment 1010. Furthermore, the positions where multiple trackers 1021, 1022, 1023, 1031, 1032, 1033 are arranged within the first zone 1020 and the second zone 1030 can vary depending on the frequency of door 1011 the cargo compartment 1010 is opened. For example, trackers 1021, 1022, 1023 may be arranged in the first zone 1020 as illustratively shown in FIG. 10, while trackers 1031, 1032, 1033 may be arranged in the second zone 1030 as exemplarily depicted in FIG. 10.

In the case of point “a,” where tracker 1021 is placed, the internal temperature may change over time to Ta1, Ta2, and so on. For example, Ta1 may be 10° C., and Ta2 may be 5° C. However, these values are not limited to these specific examples. Tracker 1023 may be placed at point “x,” and the distance between some trackers 1021, 1023 may be “p,” while the distance between certain other trackers 1023, 1031 may be “q.” At point “b,” where tracker 1033 is positioned, the internal temperature may change over time to Tb1, Tb2, and so forth. For example, Tb1 may be 10° C., and Tb2 may be 9° C. However, these values are not limited to the given examples.

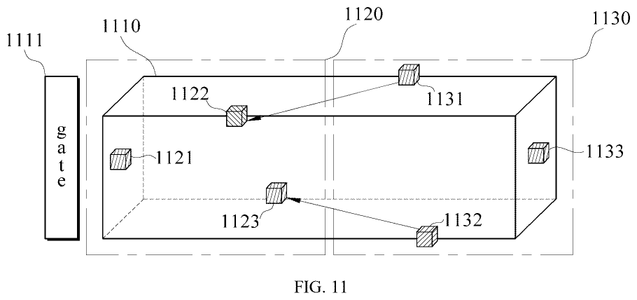

FIG. 11 is a diagram illustratively explaining zones with frequent temperature changes and zones with minor temperature variations according to the present disclosure.

Referring to FIG. 11, based on the frequency of the door 1111 opening of the cargo compartment 1110, a first zone 1120 and a second zone 1130 can be designated for precise sensing of internal temperature, vibrations, and other conditions. The first zone 1120 may be an area where temperature changes frequently, while the second zone 1130 may be a zone where temperature changes occur less frequently. The positions of multiple trackers 1121, 1122, 1123, 1131, 1132, 1133 arranged in each of the first zone 1120 and the second zone 1130 may vary accordingly. Meanwhile, at least one tracker included in a specific zone may additionally sense areas within another zone where no trackers are attached. For example, each of the trackers 1131, 1132 included in the second zone 1130 may sense areas within the first zone 1120 where trackers are not attached.

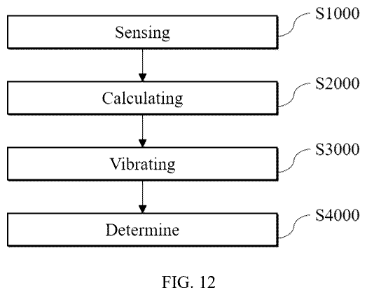

FIG. 12 is a flowchart explaining the method according to the present disclosure.

Referring to FIG. 12, a method for sensing and processing the land transportation environment of a vehicle may include a sensing step S1000, a calculation step S2000, a vibration step S3000, and a determination step S4000.

The sensing step S1000 is a step of sensing the impact on the cargo contained in the cargo compartment of the vehicle due to rapid acceleration or deceleration. This sensing step S1000 is performed by an inertial sensor 220.

The calculation step S2000 is a step of calculating a second frequency to offset a first frequency corresponding to the sensed impact. This calculation step S2000 is executed by a processor 210, for example, a first calculation unit 211 and a correction unit 212.

The vibration step S3000 is a step of generating vibrations at the second frequency. This vibration step S3000 is performed by a vibration generator 230.

The determination step S4000 is a step of determining the cause of temperature changes included in temperature data received from an external source. This determination step S4000 is executed by a processor 210, for example, a second calculation unit 213. Alternatively, the determination step S4000 can be performed by the processor 210, the second calculation unit 213) and the correction unit 212.

Meanwhile, the disclosed embodiments may be implemented in the form of a recording medium storing computer-executable instructions. The instructions may be stored in the form of program code and, when executed by a processor, generate program modules that perform the operations of the disclosed embodiments. The recording medium may be implemented as a computer-readable storage medium.

The computer-readable storage medium includes any type of storage medium that can store instructions readable by a computer. Examples of such media include ROM (Read Only Memory), RAM (Random Access Memory), magnetic tapes, magnetic disks, flash memory, optical data storage devices, etc.

As described above, the disclosed embodiments have been explained with reference to the accompanying drawings. A person skilled in the art to which this disclosure pertains would understand that various modifications and alterations can be made to the disclosed embodiments without departing from the technical spirit or essential characteristics of this disclosure. The disclosed embodiments are illustrative and should not be interpreted in a limiting manner.

### 2. Embodiment 2

A different embodiment is now described. The following embodiment illustrates a system and method for optimizing the land transportation route of a transportation means. In this disclosure, reference numerals in Embodiment 2 may indicate different configurations, even if they use the same numbers or characters as in Embodiment 1.

The term “device according to this disclosure” includes all types of devices that can perform computational processing and provide results to a user. For example, the device according to this disclosure may encompass computers, server devices, and portable terminals, or be implemented in any one of these forms.

Here, a computer may include, for example, a laptop, desktop, slate PC, or tablet PC equipped with a web browser.

A server device refers to a server that processes information by communicating with external devices and may include an application server, computing server, database server, file server, game server, mail server, proxy server, and web server.

A portable terminal may include any type of wireless communication device that ensures portability and mobility, such as PCS (Personal Communication System), GSM (Global System for Mobile communications), PDC (Personal Digital Cellular), PHS (Personal Handyphone System), PDA (Personal Digital Assistant), IMT-2000 (International Mobile Telecommunication-2000), CDMA-2000 (Code Division Multiple Access-2000), W-CDMA (Wideband Code Division Multiple Access), WiBro (Wireless Broadband Internet) terminals, and smartphones.

Wearable devices, including wrist-worn, head-worn, and other accessories such as smartwatches, rings, bracelets, anklets, necklaces, glasses, contact lenses, and head-mounted devices (HMDs), may also be included in the scope of portable terminals.

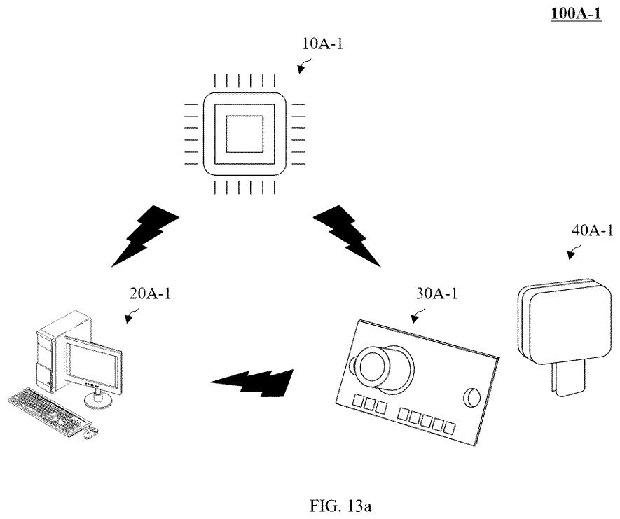

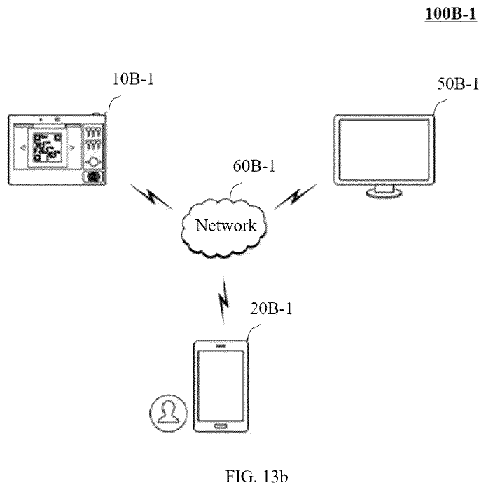

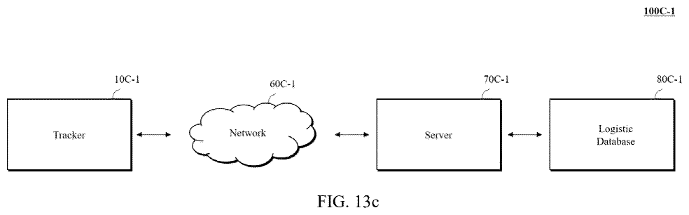

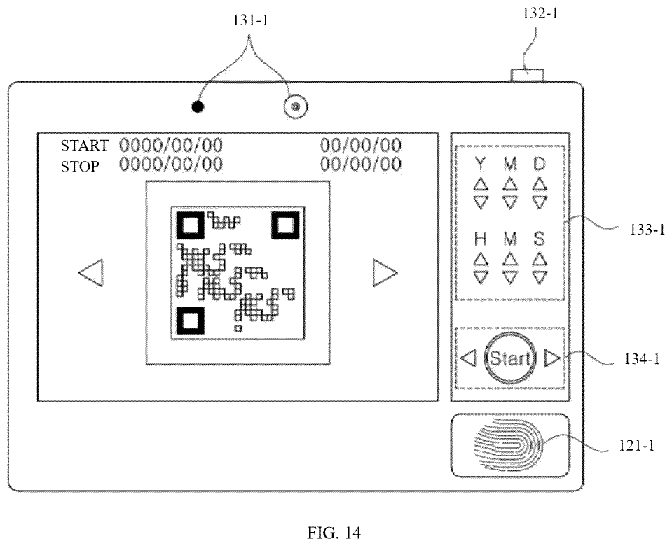

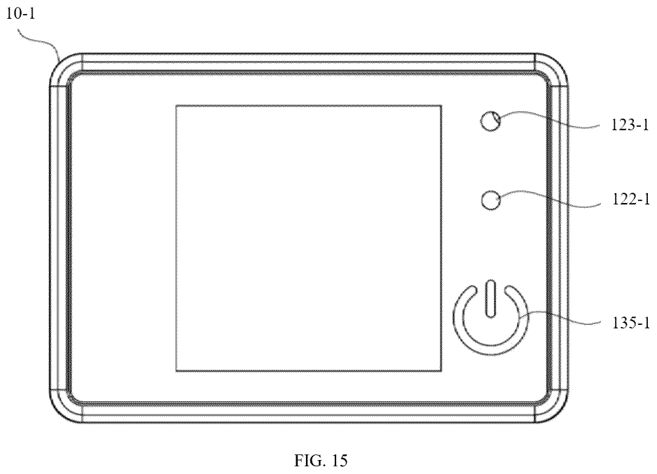

The FIGS. 13a, 13b, and 13c illustratively depict the system of the present disclosure. FIGS. 14 and 15 illustratively depict the tracker of the present disclosure. FIG. 14 shows a front view of the tracker, while FIG. 15 shows a rear view of the tracker.

Referring to FIG. 13a, to perform the operations of the present disclosure, a tracker 10A-1 for the cargo transport space, a user terminal 20A-1, a temperature measurement sensor 30A-1, and a distance measurement sensor 40A-1 may be provided.

The tracker 10A-1 encompasses various devices capable of performing computational processing and providing results to the user.

The user terminal 20A-1 may include both a computer and a portable user terminal or may be of one of these forms. Here, a computer may include, for example, a notebook, desktop, laptop, tablet PC, or slate PC equipped with a web browser.

A device (server) functions as a server that processes information by communicating with external devices. This server may include an application server, computing server, database server, file server, game server, mail server, proxy server, and web server.

A portable user terminal may include any kind of handheld-based wireless communication device ensuring portability and mobility, such as PCS (Personal Communication System), GSM (Global System for Mobile Communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (Wideband Code Division Multiple Access), WiBro (Wireless Broadband Internet) devices, smartphones, as well as wearable devices such as watches, rings, bracelets, anklets, necklaces, glasses, contact lenses, or head-mounted devices (HMDs).

The temperature and humidity measurement sensor 30A-1 may be attached inside the cargo transport space (e.g., within the cargo). It may be attached at a predetermined location set by the user. The temperature and humidity measurement sensor 30A-1 senses the temperature and humidity inside the cargo and outputs the sensing information to the tracker 10A-1. In one embodiment, the temperature and humidity measurement sensor 30A-1 may include a temperature measurement sensor and a humidity measurement sensor. The unit for temperature may be degrees Celsius (° C.), and the unit for humidity may be percentage (%), but it is not limited to these.

The distance measurement sensor 40A-1 may be attached within the cargo transport space and generate distance data by measuring the distance between multiple first positions predetermined by the user and multiple second positions, which are the remaining vertex positions where the temperature measurement sensor 30A-1 is not attached. The distance measurement sensor 40A-1 may include one of a LiDAR sensor, an ultrasound sensor, a short/medium-range radar sensor, a long-range radar sensor, or a camera.

Referring to FIG. 13b, the system 100B-1 may include a tracker 10B-1, a first user terminal 20B-1, a second user terminal 50B-1, and a communication network 60B-1. Although the number of user terminals shown in FIG. 13b is two, it is not limited to this and may be one or more than three.

The tracker 10B-1 may be a device for sensing and compensating for environmental conditions in a land transport environment of a transport vehicle. The transport vehicle may include automobiles, motorcycles, trucks, and trains. In one embodiment, the vehicle may include at least one cargo compartment, but it is not limited to this. The tracker 10B-1 may communicate with the first and second user terminals 20B-1, 50B-1 via the communication network 60B-1. The tracker 10B-1 encompasses various devices capable of performing computational processing and providing results to the user. For example, the tracker 10B-1 may include a computer, a device (server), and a portable terminal, or it may be one of these forms. Here, a computer may include, for example, a notebook, desktop, laptop, tablet PC, or slate PC equipped with a web browser. The device (server) functions as a server that processes information by communicating with external devices, including an application server, computing server, database server, file server, game server, mail server, proxy server, and web server.

Referring to FIG. 14, the front view of the tracker 10B-1 may include a sensing unit 131-1, a switch 132-1, input units 133, 134-1, a fingerprint recognition button 121-1, and a display. The user may input a start and end date on the display through the input unit 133-1.

Referring to FIG. 15, the rear view of the tracker 10B-1 may include various buttons 122-1, 123-1 and a power indicator 135-1. The input unit is for receiving information from the user, allowing the user to input data through the input unit. This input unit may include hardware-based physical keys (e.g., buttons, dome switches, jog wheels, jog switches, etc., located on at least one of the front, rear, or side surfaces of the device) and software-based touch keys. For example, a touch key may be a virtual key, soft key, or visual key displayed on a touchscreen through software processing, or a touch key arranged on a non-touchscreen area. The virtual or visual key may be displayed on the touchscreen in various forms, such as graphics, text, icons, videos, or a combination of these.

Referring again to FIG. 13b, the first user terminal 20B-1 and the second user terminal 50B-1 may include both computers and portable user terminals or may be of one of these forms. Portable user terminals may include any kind of handheld-based wireless communication device ensuring portability and mobility, such as PCS, GSM, PDC, PHS, PDA, IMT-2000, CDMA-2000, W-CDMA, WiBro, smartphones, as well as wearable devices such as watches, rings, bracelets, anklets, necklaces, glasses, contact lenses, or head-mounted devices (HMDs).

The system 100C-1, as illustrated in FIG. 13C, may include a tracker 10C-1, a server 70C-1, and a transportation database 80C-1. The system 100C-1 is designed to optimize land transportation routes for transportation means.

The tracker 10C-1 may be installed in the transportation means. It can sense transportation environment data, including the environment of the cargo contained within the transportation means. The tracker 10C-1 may transmit the transportation environment data to the server 70C-1.

The server 70C-1 analyzes the discrepancy between the expected and actual routes and calculates the impact on the cargo. For example, the server 70C-1 may generate an expected route for transportation between the departure and arrival points, record temperature, humidity, and impact on the cargo along the actual GPS-based route, and analyze the causes of discrepancies by considering factors such as i) the average speed of the transportation means and ii) regional variations in temperature, humidity, and impact. Based on these analyses, the server 70C-1 may calculate the impact of discrepancies on the cargo.

Additionally, the server 70C-1 may construct a logistics database. It can collect micro-scale local factors affecting the actual land transportation route, derive correlations among these factors, and compute weight values to minimize discrepancies. Examples of these micro factors may include road impact, speeding zones, curves, dwell times at stops, and loading/unloading times.

Based on the transportation environment data, the server 70C-1 may analyze the discrepancy between the expected and actual transportation routes from the departure to the arrival point and calculate an impact level indicating the degree to which discrepancies affect the cargo. Furthermore, the server 70C-1 may optimize the transportation route based on the discrepancies and the calculated impact.

The server 70C-1 may take real-time traffic conditions into account. By considering real-time traffic, the server 70C-1 can reduce logistics costs, ensure on-time deliveries, and enhance customer satisfaction by improving SLA compliance. The server 70C-1 may execute software that plans routes and calculates estimated time of arrival (ETA) based on dynamic real-time data.

Moreover, the server 70C-1 may establish transportation constraints for orders. For instance, electronic products and perishable goods may be transported together, while specific items such as pharmaceuticals must be transported only in specialized vehicles. The software considering these constraints can assist businesses in real-world scenarios.

The server 70C-1 may perform precise geocoding by converting addresses into specific latitude and longitude coordinates on a map, understanding ambiguous addresses in a local context, and maintaining a comprehensive database of local addresses and apartment locations.

Furthermore, the server 70C-1 may inspect past data. It executes route optimization software by examining historical data at three levels: passengers, customers, and time. The past data of a rider may provide insights into their skills, expertise, preferred delivery times, and preferred work areas. Similarly, customer past data may indicate preferred time slots, availability, and special delivery instructions, while historical records for specific times of the day may offer insights into typical traffic conditions and business hours of particular buildings.

The route optimization software executed on the server 70C-1 may learn from past experiences and plan routes accordingly. It can also consider rider preferences. One of the biggest challenges in implementing route planning is resistance from field operation teams. Since these teams are accustomed to specific work processes, changing the entire operational system can be a significant transition. To facilitate this transition, the software may incorporate the preferences of field teams and phase out existing systems gradually instead of replacing them abruptly.

The server 70C-1 may perform change management. If field teams insist on maintaining traditional methods, software providers may assign expert teams to convince and support the transition. Training modules, incentives, and success stories from other organizations can motivate field staff to adopt the route optimization software.

Additionally, the server 70C-1 may conduct analysis and report management. The route optimization software may enable tracking and management of entire operations in real time on a single platform. This allows tracking of actual versus planned routes and helps compare performance across various business hubs. The software may also provide an integrated dashboard for real-time task tracking.

The server 70C-1 may enable dynamic route planning. The software may support optimally processing both scheduled and on-demand orders. On-the-go route changes are another increasingly preferred feature by companies. If a customer modifies an order or preference while a rider is out for delivery, the route optimization software can adjust and generate a new route for the rider. As routing requirements become more complex, the server 70C-1 may allow businesses to select Route Optimization software according to their needs.

The transportation database 80C-1 may be constructed to optimize transportation routes and store various data.

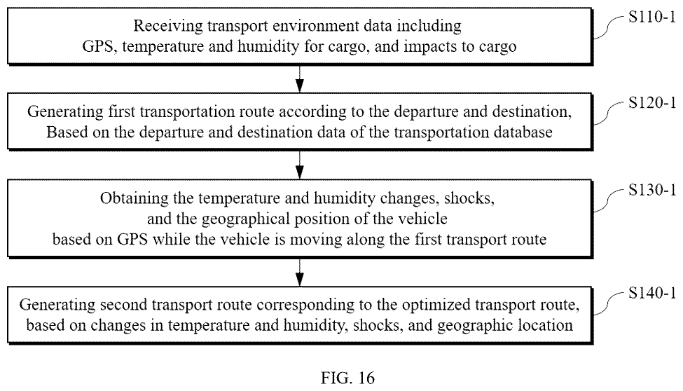

FIG. 16 illustrates a flowchart describing an exemplary method for optimizing transportation routes in accordance with the present disclosure.

Referring to FIG. 16, in step S110-1, the server 70C-1 may receive transportation environment data, including Global Positioning System (GPS) data, temperature and humidity of the cargo, and impacts on the cargo. For instance, the tracker 10C-1 may transmit transportation environment data-including GPS-based location information, temperature, humidity, and impact data-to the server 70C-1.

In step S120-1, the server 70C-1 may generate a first transportation route based on the departure and destination data stored in the transportation database 80C-1. For example, the server 70C-1 may generate the first transportation route based on the departure and destination data stored in the transportation database 80C-1.

In step S130-1, the server 70C-1 may acquire data regarding changes in temperature and humidity, impact events, and GPS-based geographic locations while the transportation means is moving along the first transportation route.

In step S140-1, based on changes in temperature and humidity, impact events, and geographic locations, the server 70C-1 may generate a second transportation route corresponding to an optimized transportation route.

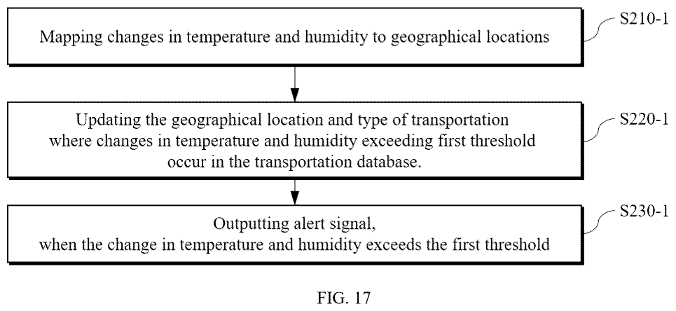

FIG. 17 is a flowchart illustrating an embodiment of generating alerts based on changes in temperature and humidity according to the present disclosure.

Referring to FIG. 17, in step S210-1, the server 70C-1 may map changes in temperature and humidity to a geographic location.

In step S220-1, the server 70C-1 may update the transportation database 80C-1 with the geographic location where temperature and humidity changes exceeding a first threshold occur and the type of transportation means.

In step S230-1, the server 70C-1 may output an alert signal indicating an alert (alert-1) when the changes in temperature and humidity exceed the first threshold.

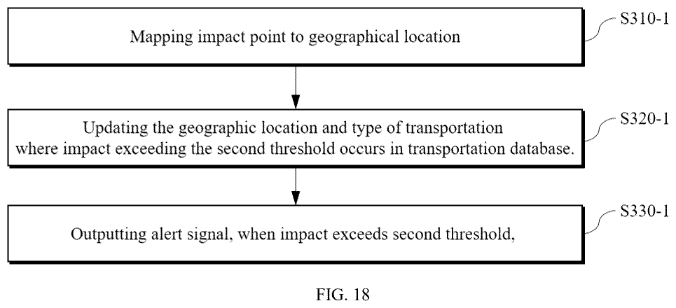

FIG. 18 is a flowchart illustrating an embodiment of generating alerts based on impact according to the present disclosure.

Referring to FIG. 18, in step S310-1, the server 70C-1 may map impact to a geographic location.

In step S320-1, the server 70C-1 may update the transportation database 80C-1 with the geographic location where an impact exceeding a second threshold occurs and the type of transportation means.

In step S330-1, the server 70C-1 may output an alert signal when the impact exceeds the second threshold.

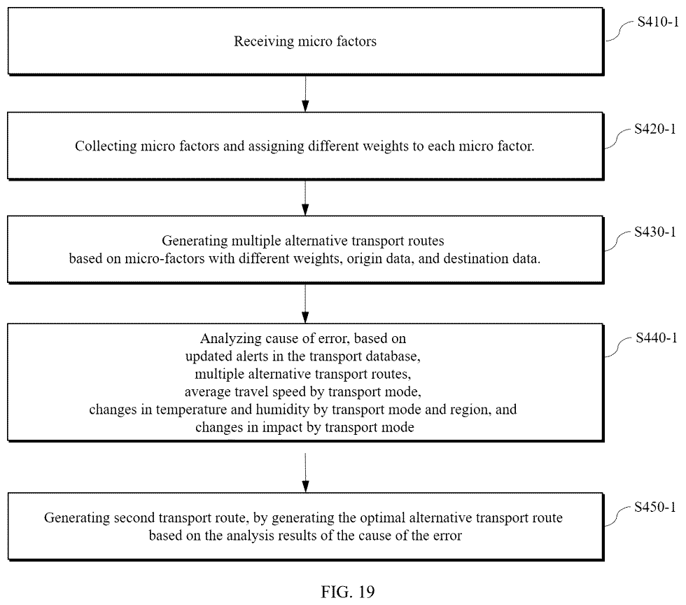

FIG. 19 is a flowchart illustrating another embodiment of optimizing a transportation route according to the present disclosure.

Referring to FIG. 19, in step S410-1, the server 70C-1 may receive microscopic factors. For example, the tracker 10C-1 may transmit microscopic factors to the server 70C-1. Microscopic factors may include road shocks occurring on the surface where the transportation means is moving. Microscopic factors may also include overspeeding sections on the actual transportation route, curves present on the actual transportation route, and dwell time indicating how long the transportation means stays at dwell locations along the transportation route. For example, a dwell location may include rest stops, drowsiness shelters, shoulders, roads with low vehicle traffic, and sparsely populated pedestrian paths, encompassing both official and temporary dwell locations where vehicles can stop for a certain period. Microscopic factors may also include loading and unloading times of the transportation means, the transportation duration required for cargo transport, the total transportation distance, the rate of temperature and humidity change, the frequency of impacts, and the type of transportation means.

In step S420-1, the server 70C-1 may collect microscopic factors and assign different weights to each of them.

In step S430-1, based on the weighted microscopic factors, departure data, and arrival data, the server 70C-1 may generate multiple alternative transportation routes.

In step S440-1, the server 70C-1 may analyze the cause of errors based on alerts updated in the transportation database 80C-1, multiple alternative transportation routes, the average travel speed per transportation means, temperature and humidity changes per transportation means and region, and impact variations per transportation means.

In step S450-1, the server 70C-1 may generate an optimized alternative transportation route based on the error cause analysis result, thereby creating a second transportation route.

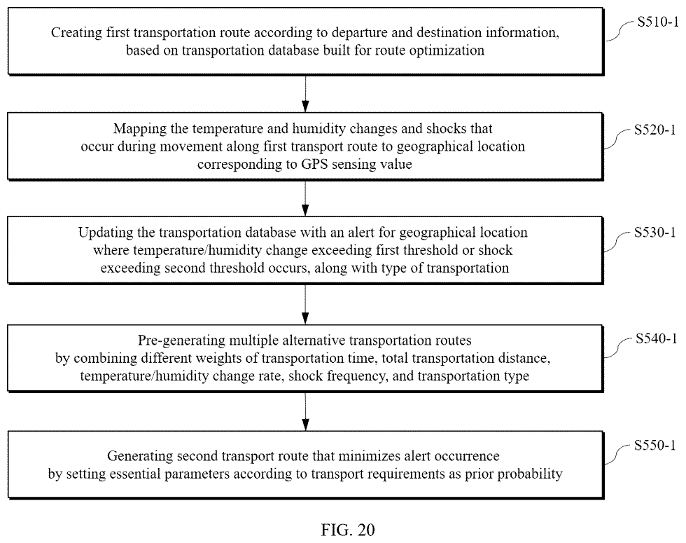

FIG. 20 is a flowchart illustrating another embodiment of optimizing a transportation route according to the present disclosure.

Referring to FIG. 20, in step S510-1, the server 70C-1 may generate a first transportation route based on departure and arrival information using the transportation database 80C-1 built for route optimization.

In step S520-1, the server 70C-1 may map temperature and humidity changes and impact occurring during travel along the first transportation route to geographic locations corresponding to GPS sensing values.

In step S530-1, the server 70C-1 may update the transportation database with alerts at geographic locations where temperature and humidity changes exceed a first threshold or impact exceeds a second threshold, along with the type of transportation means.

In step S540-1, the server 70C-1 may pre-generate multiple alternative transportation routes by combining different weight-assigned transportation duration, total transportation distance, rate of temperature and humidity change, frequency of impact, and transportation means type.

In step S550-1, the server 70C-1 may generate a second transportation route that minimizes alert occurrences by setting essential parameters based on transportation requirements as prior probability.

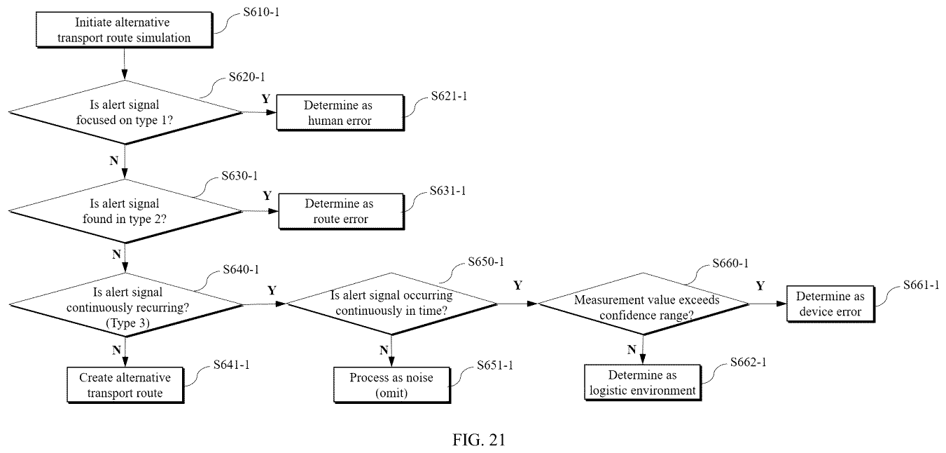

FIG. 21 is a flowchart illustrating an embodiment of analyzing the cause of errors for each alternative transportation route according to the present disclosure.

Referring to FIG. 21, in step S610-1, the server 70C-1 may initiate a simulation of the alternative transportation routes. For example, the server 70C-1 may simulate the transportation means virtually moving along each alternative transportation route.

In step S620-1, the server 70C-1 may determine whether alert signals are concentrated in a first type. The first type may correspond to areas where variations due to the driver's actions are relatively high. That is, the first type may geographically correspond to areas such as rest stops and merge sections, where driver-induced variations are likely. For example, the server 70C-1 may determine whether the alert signals correspond to the first type.

If the alert signals correspond to the first type (S620, Y), in step S621, the server 70C-1 may determine the error cause as a human error.

If the alert signals do not correspond to the first type (S620, N), in step S630-1, the server 70C-1 may determine whether alert signals are found in a second type. The second type may correspond to locations where the transportation means deviates from the alternative transportation route. That is, the second type may refer to cases where the transportation means is detected outside the expected transportation radius. For example, the server 70C-1 may determine whether the alert signals correspond to the second type.

If the alert signals correspond to the second type (S630, Y), in step S631, the server 70C-1 may determine the error cause as a route error.

If the alert signals do not correspond to the second type (S630, N), in step S640-1, the server 70C-1 may determine whether the alert signals occur repeatedly. In this case, continuously recurring alert signals may be referred to as a third type, corresponding to errors occurring in the actual cargo or tracker. That is, the third type may correspond to cases where the cargo has an issue or the device itself has a malfunction. For example, the server 70C-1 may determine whether the alert signals correspond to the third type.

If the alert signals do not correspond to the third type (S640, N), in step S641, the server 70C-1 may generate an alternative transportation route.

If the alert signals correspond to the third type (S640, Y), the server 70C-1 may determine the error cause as another error type. Specifically, in step S650-1, the server 70C-1 may determine whether the alert signals occur continuously over time.

If the alert signals correspond to the third type but occur intermittently (S650, N), in step S651, the server 70C-1 may process noise.

If the alert signals correspond to the third type and occur continuously (S650, Y), in step S660-1, the server 70C-1 may determine whether the measured values exceed a reliability the measured values may be the collected range. Here, microscopic factors.

If the alert signals correspond to the third type, occur continuously, and the collected values exceed the reliability range (S660, Y), in step S661, the server 70C-1 may determine the error cause as a device error or tracker error.

If the alert signals correspond to the third type, occur continuously, but the collected microscopic factor values are within the reliability range (S660, N), in step S662, the server 70C-1 may determine the error cause as a cargo transportation environment issue (or cargo transportation environmental error).

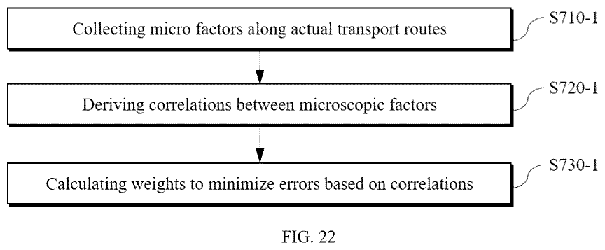

FIG. 22 is a flowchart illustrating an embodiment for calculating the correlation and weights among the microscopic factors of the present disclosure.

Referring to FIG. 19, in step S710-1, the server 70C-1 may collect microscopic factors along the actual transportation route.

In step S720-1, the server 70C-1 may derive the correlation between the microscopic factors.

In step S730-1, the server 70C-1 may calculate weights to minimize errors based on the correlation.

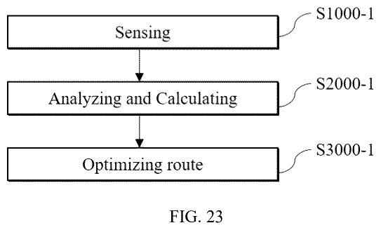

FIG. 23 is a flowchart illustrating a method according to the present disclosure.

Referring to FIG. 23, a method for optimizing a land transportation route of a transport means may include a sensing step S1000-1, an analysis and calculation step S2000-1, and a route optimization step S3000-1.

The sensing step S1000-1 is a step of sensing transportation environment data, including the environment of the cargo contained in the transport means. The sensing step S1000-1 is performed by the tracker 10C-1.

The analysis and calculation step S2000-1 is a step of analyzing the error between the expected transportation route and the actual transportation route for transporting the cargo from the departure point to the destination of the transport means based on the transportation environment data and calculating an impact degree indicating the extent to which the error affects the cargo. The analysis and calculation step S2000-1 is performed by the server 70C-1.

The route optimization step S3000-1 is a step of optimizing the transportation route based on the error and the impact degree. The route optimization step S3000-1 is performed by the server 70C-1.

Meanwhile, the disclosed embodiments may be implemented in the form of a storage medium storing computer-executable instructions. The instructions may be stored as program code, which, when executed by a processor, generates program modules to perform the operations of the disclosed embodiments. The storage medium may be implemented as a computer-readable storage medium.

A computer-readable storage medium includes any type of storage medium that can store instructions readable by a computer. Examples of such storage media include Read-Only Memory (ROM), Random Access Memory (RAM), magnetic tapes, magnetic disks, flash memory, and optical data storage devices.

As described above, the disclosed embodiments have been explained with reference to the accompanying drawings. A person of ordinary skill in the technical field to which the present disclosure belongs will understand that the disclosed embodiments can be implemented in different forms without changing the technical concept or essential features of the present disclosure. The disclosed embodiments are merely exemplary and should not be construed as limiting.

### 3. Embodiment 2 Components

claim 1: A system for optimizing a land transportation route of a transport means, comprising: a tracker disposed in the transport means, sensing transportation environment data including the environment of the cargo contained in the transport means, and transmitting the transportation environment data; a server that, based on the transportation environment data, analyzes the error between the expected transportation route and the actual transportation route for transporting the cargo from the departure point to the destination of the transport means, calculates an impact degree indicating the extent to which the error affects the cargo, and optimizes the transportation route based on the error and the impact degree; and a transportation database constructed for optimizing the transportation route.

Claim 2: The system of claim 1, wherein the tracker transmits transportation environment data, including a Global Positioning System (GPS) location of the transport means, temperature and humidity of the cargo, and impact applied to the the cargo, to the server; server generates a first transportation route based on departure data and destination data stored in the transportation database; the server acquires changes in temperature and humidity, impact, and the geographical location of the transport means during movement along the first transportation route; and the server generates a second transportation route corresponding to an optimized transportation route based on the changes in temperature and humidity, impact, and geographical location.

Claim 3: The system of claim 2, wherein the server maps changes in temperature and humidity to geographical locations, updates the transportation database with geographical locations where changes in temperature and humidity exceed a first threshold and with the type of transport means, and outputs an alert signal when the changes in temperature and humidity exceed the first threshold.

Claim 4: The system of claim 3, wherein the server maps impact to geographical locations, updates the transportation database with geographical locations where impact exceeding a second threshold occurs and with the type of transport means, and outputs the alert signal when the impact exceeds the second threshold.

Claim 5: The system of claim 4, wherein the tracker transmits micro factors to the server, including road surface shocks occurring on the road surface where the transport means moves, speeding sections along the actual transport route, curves on the actual transport route, dwell time indicating the duration the transport means stays at a dwelling place located around the actual transport route, loading and unloading times of the transport means, transport duration indicating the time required for the transport means to transport the cargo, total transport distance indicating the travel distance required for the transport means to transport the cargo, temperature and humidity variation rate, impact occurrence frequency indicating the frequency of impacts, and the type of transport means, and wherein the server collects the micro factors, assigns different weights to each of the micro factors, generates multiple alternative transport routes based on the weighted micro factors, departure data, and arrival data, analyzes the causes of deviations based on alerts updated in the transport database, multiple alternative transport routes, the average travel speed of the transport means, regional and transport means-specific temperature and humidity changes, and impact variations per transport means, and generates the second transport route by creating an optimal alternative transport route based on the analysis results of the causes of deviations.

Claim 6: The system of claim 5, wherein the server initiates a simulation of virtual movement along each alternative transportation route, determines the error cause as human error if the alert signal corresponds to a first type associated with a high likelihood of variation by the driver, determines the error cause as a route error if the alert signal corresponds to a second type associated with the transport means deviating from the alternative transportation route, and determines the error cause as an other error if the alert signal corresponds to a third type related to an error in the actual cargo or tracker.

Claim 7: The system of claim 6, wherein the server processes noise if the alert signal corresponds to the third type and occurs discontinuously over time, determines the error cause as a tracker error if the alert signal corresponds to the third type and occurs continuously over time while collected values exceed a reliability threshold, and determines the error cause as a cargo transportation environment error if the alert signal corresponds to the third type and occurs continuously over time while collected microscopic factor values remain within the reliability threshold.

Claim 8: The system of claim 7, wherein the server collects microscopic factors along the actual transportation route, derives the correlation between the microscopic factors, and calculates weights to minimize errors based on the correlation.

Claim 9: A method for optimizing a land transportation route of a transport means, comprises: sensing transportation environment data including the environment of the cargo contained in the transport means; analyzing the error between the expected transportation route and the actual transportation route and calculating an impact degree indicating the extent to which the error affects the cargo, based on the transportation environment data; and optimizing the transportation route based on the error and the impact degree.

Claim 10: A computer program stored in a recording medium, which executes the method of claim 9 in conjunction with hardware.

1. A device for sensing and processing a land transportation environment of a vehicle, comprising:
an inertial sensor configured to sense an impact on cargo contained in the cargo compartment of the vehicle due to rapid acceleration or deceleration of the vehicle;
a processor configured to, based on a first frequency corresponding to the impact sensed by the inertial sensor, calculate a second frequency to cancel out the first frequency, and outputs a control signal including the second frequency;
a vibration generator configured to vibrate at the second frequency in response to the control signal; and
a memory configured to store pattern data and flag data, the pattern data comprising characteristics of a plurality of predefined patterns and a plurality of pattern identifiers representing each of the plurality of predefined patterns, and the flag data comprising flags representing whether an external environmental factor or transporter intervention is involved based on each of the plurality of pattern identifiers,
wherein the processor further configured to:
load the pattern data and the flag data from the memory,
extract the characteristics of the plurality of predefined patterns to be identified based on sequential temperature values over time included in temperature data received from an external source,
identify a pattern of temperature change by obtaining the plurality of predefined pattern identifiers of the patterns based on the extracted characteristics and the pattern data, and
determine, based on the identified pattern, whether the change in temperature is caused by the external environment or by the transporter intervention.

2. The device of claim 1, wherein the processor comprises:
a first computation unit configured to calculate the phase of each of first signals inducing the impact; and
a correction unit configured to generate second signals, each having a phase opposite to that of the corresponding first signals, and output a control signal including the second signals to the vibration generator.

3. The device of claim 2, wherein the inertial sensor is configured to sense a natural frequency generated as the cargo oscillates vertically within a unit time due to the acceleration and inertial direction of the vehicle,
and wherein the first computation unit is configured to calculate the phase of each of the first signals based on the acceleration of the vehicle and the physical properties of the cargo based on a mass of the cargo,
and wherein the correction unit is configured to generate the second signals having the same natural frequency and amplitude but an opposite phase.

4. The device of claim 3, wherein the processor further comprises a second computation unit configured to:
analyze a pattern of temperature variations included in received external temperature data,
diagnose cause of the temperature variation by determining whether the temperature variation is caused by external environmental factor or intervention of transporter, and
generate cause data including the cause of the temperature variation.

5. The device of claim 4, wherein the second computation unit is configured to
diagnose the cause based on the acquired pattern identifier and the flag data.

6. The device of claim 5,
wherein the processor further comprises a neural network processing unit configured to create an artificial intelligence model trained with a learning dataset, including a first data comprising points representing sequential temperature values over time, and a second data comprising pattern identifiers corresponding to graphs formed by connecting the points,
wherein the second computation unit is configured to:
input data including the points into the artificial intelligence model,
predict the pattern identifier as output from the artificial intelligence model,
and determine the pattern by searching for a matching pattern identifier among the multiple pattern identifiers.

7. The device of claim 6, wherein the second computation unit is configured to estimate a trend line representing the trend of temperature variations over time based on the temperature data and the cause data.

8. The device of claim 7, further comprising a communication module configured to transmit the cause data to an external device via a communication network,
wherein the second computation unit is configured to controls the memory to store the cause data.

9. A method for sensing and processing a land transportation environment of a vehicle, comprises:
sensing an impact on cargo contained in the cargo compartment of a vehicle due to rapid acceleration or deceleration, and a first frequency corresponding to the sensed impact;
calculating a second frequency to cancel out the first frequency;
vibrating at the second frequency; and
determining cause of temperature variations of temperature data based on received external temperature data,
wherein the determining comprises:
loading pattern data and flag data, the pattern data comprising characteristics of a plurality of predefined patterns and a plurality of pattern identifiers representing each of the plurality of predefined patterns, and the flag data comprising flags representing whether an external environmental factor or transporter intervention is involved based on each of the plurality of pattern identifiers,
extracting the characteristics of the plurality of predefined patterns to be identified based on sequential temperature values over time included in temperature data received from an external source,
identifying a pattern of temperature change by obtaining the plurality of predefined pattern identifiers of the patterns based on the extracted characteristics and the pattern data, and
determining, based on the identified pattern, whether the change in temperature is caused by the external environment or by the transporter intervention.

10. A computer program stored in a recording medium, which, when combined with hardware, executes the method of claim 9.
